(19) United States
(12) Patent Application Publication
(10) Pub. No.: US 2016/0278348 A1
(43) Pub. Date: Sep. 29, 2016

(54) METHOD FOR CONTROLLING WATER MOLDS IN AQUACULTURE WATER

(71) Applicant: SUKEGAWA CHEMICALS CO., LTD., Kobe-shi, Hyogo (JP)

(72) Inventor: Susumu Sukegawa, Kobe-shi, Hyogo (JP)

(73) Assignee: SUKEGAWA CHEMICALS CO., LTD., Kobe-shi, Hyogo (JP)

(21) Appl. No.: 15/034,774

(22) PCT Filed: Apr. 6, 2015
(86) PCT No.: PCT/JP2015/001933

§ 371 Date: May 5, 2016

(30) Foreign Application Priority Data
Oct. 21, 2014 (JP) 2014-214767

(51) Int. Cl. A01K 63/04; C02F 1/76

(52) U.S. Cl. CPC A01K 63/04; C02F 1/76; C02F 2103/20

(57) ABSTRACT

Disclosed herein is a method for controlling water molds in aquaculture water by using chlorine dioxide that is less toxic and safer than bronopol.

The method includes adding chlorite to aquaculture water with a pH of 5.5 or higher but 8.5 or lower at a concentration of 2.5 ppm or higher but 200 ppm or lower in terms of effective chlorine dioxide and performing a reaction for 60 minutes or longer to control water molds. At this time, an organic or inorganic acid is not added to the aquaculture water. The aquaculture water includes water for hatching or water for fanning. Further, the aquaculture water includes both seawater and freshwater.

### TECHNICAL FIELD

The present invention relates to a method for controlling water molds in freshwater or seawater for aquaculture by using chlorite (chlorine dioxide as an active ingredient).

### BACKGROUND ART

In recent years, culture fishery has been widely carried out to secure fishing resources. However, bacterial or viral infections offish and shellfish due to, for example, deterioration of fishery environment caused by water pollution have become a major problem. Among such infections of Mi and shellfish, water-mold disease is an infection generally caused by infection with Saprolegnia (oomycetes), and is therefore called Saprolegniasis. Infection with Saprolegnia leads to inflammation or ulcer due to white or gray spawn (water molds) growing at wounds on fish or egg surfaces. Further, water-mold disease occurs with infection with bacteria belonging to the genus Aeramonas or the like, and infected subjects finally result in death. Further, water-mold disease also causes the death offish eggs due to the lack of oxygen at the time of hatching. Water-mold disease is caused by oomycetes, and therefore it is impossible to apply measures against molds caused by fungi to water-mold disease.

As a prophylactic and therapeutic agent effective for water-mold disease in fish, malachite green has heretofore been widely used. However, it has been pointed out that malachite green is carcinogenic and teratogenic in animals, and therefore the Pharmaceutical Affairs Act currently prohibits the use of malachite green for cultured fish. Further, the Food Sanitation Act prohibits the distribution and sale of cultured fish in which malachite green has been detected. Therefore, low-toxic prophylactic and therapeutic agents for water-mold disease are expected to be developed. On the other hand, since the prohibition of the use of malachite green, a disease that causes the death offish frilly covered with water molds has frequently occurred in fish farms or fish hatcheries in various places, which is a major problem in the field of fishery in our country.

Patent Literature 1 discloses that the electrolysis of tap water or water obtained by adding an electrolysis aid such as salt to tap water forms highly acidic water on the positive electrode side and highly alkaline water on the negative electrode side, and the highly acidic water contains residual chlorine (dissolved chlorine) such as hypochlorous acid (HOCl), hypochlorite ion (OCl⁻), or chlorine gas (Cl₂), and the residual chlorine, especially hypochlorous acid is effective for zoospores and hyphae of water molds.

Patent literature 2 discloses a therapeutic or prophylactic agent for infections of fish and shellfish including various water-soluble minerals extracted from incinerated organisms. Fish and shellfish or eggs offish and shellfish are immersed in an aqueous solution of the water-soluble minerals to cure or prevent infections offish and shellfish.

Patent Literature 3 discloses a water-mold, control agent for aquaculture including, as an active ingredient a specific benzothiazolylazo compound.

Recently, it has been reported that Pyceze (trademark of Novartis Animal Health K.K.) containing bronopol as an active ingredient is suitable for sterilization offish eggs to be hatched (suppression of epidemic parasitic overgrowth of water molds) (Non-Patent literatures 1 to 3).

On the other hand, chlorite (chlorine dioxide as an active ingredient) attracts attention as a low-toxic sterilizer also in the field of fishery. Patent literature 4 discloses the use of chlorine dioxide at a concentration of 0.01 to 2 mg/L to sterilize aquaculture water for the purpose of preventing fish viral diseases such as koi herpes. Patent Literature 5 discloses that pathogens attached to fertilized eggs of fish and shellfish are lolled by immersing the fertilized eggs in water having a chlorine dioxide concentration of 0.01 to 1 mg/L for the purpose of increasing the hatching rate of the fertilized eggs. Patent literature 6 discloses that chlorine dioxide is effective also for scuticociliatosis that is a fish parasitic disease.

### CITATION LIST

### Patent Literature

PTL1: JP 2001-238561A

PTL2: JP 2009-23997 A

PTL3: JP 61-60041 B

PTL4: JP 2006-280212 A

PTL5: JP 2007-259808 A

PTL6: JP 3882939 B1

### Non-Patent Literature

Non-PTL1: Information from Nagano Prefectural Fisheries Experimental Station, Recommendation of use of Pyceze for control of water molds on fish eggs, updated on Jun. 20, 2014

Non-PTL2: News from Fuji Trout farm, No. 190, January 2006 issue, Fuji Trout farm under Shizuoka Prefectural Fisheries Experimental Station

Non-PTL3: FRA Salmonid Research Report, No. 5, March 2011, pp. 15-17

### SUMMARY OF INVENTION

### Technical Problem

The inventions disclosed in PTLs 4 to 6 relate to the use of chlorous acid or chlorine dioxide in file field of fishery, but are not intended to control water-mold disease. On the other hand, the method disclosed in PTL1 is considered to be impractical because residual chlorine significantly affects fish. Further; the methods disclosed in PTLs 2 and 3 are in fact not popular as measures against water-mold disease in fish farms, either.

That is, the fact is that there is no other chemical than bronopol, which can be currently used in our country to prevent water-mold disease in fish farms or fish hatcheries. Bronopol is less toxic than malachite green, but its use is limited to once per day at 50 ppm for 1 hour or at 100 ppm for 30 minutes. When bronopol is used for fertilized eggs, the period of use is limited up to the eyed period. Further, 3333-fold dilution or 6666-fold dilution is required before water discharge when the concentration of bronopol is 50 ppm or 100 ppm. respectively. That is, the concentration of bronopol in discharged water is limited to 0.015 ppm or less.

On the other hand, chlorine dioxide is used for, for example, killing bacteria or controlling molds, but no wafer-mold control agent containing chlorine dioxide is commercially available. Further, there is no public trade record of using chlorine dioxide in fish farms or fish hatcheries for the purpose of controlling water-mold disease. The same goes for a chlorite preparation containing chlorine dioxide as an active sterilizing ingredient.

It is an object of the present invention to provide a method for controlling water molds in aquaculture water by using chlorine dioxide that is less toxic and safer than bronopol.

### Solution to Problem

Chlorine dioxide (ClO₂) is a gas at ordinary temperature. Therefore, an organic or inorganic acid is added to an aqueous solution of chlorite such as sodium chlorite (NaClO₂) or potassium chlorite (KClO₂) (pH about 12) to make the solution acidic to generate chlorine dioxide. In an alkaline aqueous solution, chlorite is stably present as chlorite ion (ClO2⁻). On the other hand, in an acidic aqueous solution, chlorite is present in a state where chlorous acid (HClO₂), chlorite ion, and chlorine dioxide arc present together.

When used for sterilization, chlorite is generally used together with an organic or inorganic acid. When chlorous acid is used in the field of fishery an organic or inorganic acid is sometimes not used as described in PTL 4 or 5. According to PTL 4 or 5, chlorine dioxide is effective for viruses or pathogens at a low concentration of 1 ppm or less. However, a chlorine dioxide preparation cannot be expected to be effective as a measure against water molds. Therefore, a chlorine dioxide preparation has not heretofore been practically used as a means for controlling water molds. As described above, a bronopol preparation is foe only preparation that is currently approved for practical use in our country.

The present inventor has intensively studied the use of chlorine dioxide, which is less toxic and safer than bronopol, for the control of water molds. As a result, the present inventor has found that, surprisingly, when an organic or inorganic acid is not used and the concentration of chlorine dioxide in aquaculture water is made higher than that disclosed in PTL 4 or 5, a water-mold control effect higher than that of a bronopol preparation is exerted. This finding has led to the completion of fee present invention.

More specifically the present invention is directed to a method for controlling water molds in aquaculture water by using chlorite, the method including

adding chlorite to aquaculture water with a pH of 5.5 or higher but 8.5 or lower at a concentration of 2.5 ppm or higher but 200 ppm or lower in terms of effective chlorine dioxide and performing a reaction for 60 minutes or longer to control water molds, wherein

an organic or inorganic acid is not added to the aquaculture water.

Chlorite is added to aquaculture water with a pH of 5.5 or higher but 8.5 or lower at a concentration of 2.5 ppm or higher but 200 ppm or lower in terms of effective chlorine dioxide, and then after a lapse of 60 minutes or longer, zoospores of water molds can be killed, and the occurrence of “haze” can be suppressed even when the aquaculture water is used without change. Further, the surface of fish eggs can also be sterilized to suppress the growth of water molds. A chlorine dioxide preparation has been used to control fish diseases such as white spot disease. However, the fact that a chlorine dioxide preparation is very effective also at controlling water-mold disease has first been found by the present inventor.

Here, “aquaculture water” in the present invention includes not only water used for fish culture but also water used for hatching offish eggs (water for hatching). Further, “aquaculture water” includes both, seawater and freshwater. Further, “aquaculture water” includes also water used for farming fish not for breeding.

Further, the concentration “in terms of effective chlorine dioxide” in the present invention is a measured value of the concentration of chlorine dioxide in water, and can be measured by a sodium chlorite determination method disclosed in the eighth edition of Japanese Standards of Food Additives or a commercially-available measuring instrument (e.g., AL100-MT manufactured by MK Scientific, Inc.).

Various chemicals or the like are added to and various organic substances are present in aquaculture water. Therefore, even when chlorite is added to aquaculture water to achieve a predetermined chlorine dioxide concentration, generated chlorine dioxide is consumed by chemicals, organic substances, or the like so that the concentration of effective chlorine dioxide is reduced. For example, water for hatching fish eggs uses a large amount of catechin to strengthen the egg membrane. However, catechin is a type of reducing agent, and therefore chlorine dioxide as an oxidant is consumed by catechin before used for suppressing the growth of water molds. Therefore, it is important for suppressing the growth of water molds in aquaculture water to adjust the concentration of effective chlorine dioxide, which remains in the aquaculture water and exerts a sterilizing effect, to a value within an appropriate range.

Chlorite added to aquaculture water may be in the form of either powder or aqueous solution. In the present invention, the concentration of chlorite in aquaculture water with a pH of 5.5 or higher but 8.5 or lower shall be in the range of 2.5 ppm or higher but 200 ppm or lower in terms of effective chlorine dioxide. Particularly, when chlorite is added to aquaculture water in the form of aqueous solution, chlorous acid water as a food additive may be added.

Here, “an organic or inorganic acid is not added to the aquaculture water” in the present invention includes not only a case where an organic or inorganic acid is not added to the aquaculture water at all but also a case where an organic or inorganic acid is added at a concentration of 4 ppm or lower. Similarly “an organic or inorganic acid is not contained” in the present invention includes not only a case where an organic or inorganic acid is not contained at all but also a case where when added to aquaculture water; an organic or inorganic acid is contained at a concentration of 4 ppm or lower.

### Advantageous Effects of Invention

According to the present invention, it is possible to effectively control water-mold disease in aquaculture water with higher safety at lower cost. Further, it is possible to eliminate the need for dilution of aquaculture water before discharge.

### DESCRIPTION OF EMBODIMENTS

An embodiment for carrying out the present invention will be described below. The present invention is not limited to the following description.

[Experiment 1: Sensitized Time 30 min]

Based on “Testing Methods for City Water (2001 edition) by Japan Water Works Association, VIII Microbial Tests, 4.4.2.2 Water Mold Culture Method”, one hempseed cotyledon with water molds and 300 mL of sterilized tap water were placed in a sterilized 500-mL conical flask, and then 5 sterilized hempseed cotyledons were placed in the conical flask and cultured at ordinary temperature. The water molds (genus Saprolegnia) were collected from a hatchery in a fish farm for salmons and trout. After 15 days, the water in the conical flask was observed with a microscope (1000-fold magnification) to determine the presence and quantity of zoospores of the water molds. The water in fee conical flask was diluted with sterilized tap water to prepare a zoospore suspension containing 10 to 12 zoospores of the water molds per 100 μL. It is to be noted that the tap water used was city water (pH 6.0) in Kobe.

The zoospore suspension was added to a sterilized tube (5 mL capacity) containing 3 hempseed cotyledons and stirred, and was then allowed to stand at room temperature for 3 days. After 3 days, 900 μL of a chemical solution was added to the sterilized tube, and the resulting mixture was stirred and then allowed to stand for 30 minutes for sensitization. Alter the sensitization, the liquid in the sterilized tube was discharged, and only the hempseed cotyledons were transferred into a glass petri dish containing 40 mL of sterilized tap water and cultured at 15° C. for 7 days.

After 7 days, the glass petri dish was observed with a microscope to determine the following two points: (1) whether or not zoospores were present in the water in the glass petri dish: and (2) whether or not “haze” occurred in fee water in the glass petri dish. Based on the results of the observation, the minimum killing concentration of an active ingredient contained in the chemical solution was determined.

The chemical solution used here was each of the following four chemical solutions: chemical solution 1: aqueous sodium chlorite solution; chemical solution 2: aqueous solution containing the same percentage by mass of sodium chlorite and malic acid; chemical solution 3: aqueous solution containing file same percentage by mass of sodium chlorite, hydrochloric acid, and ferrous sulfide; and chemical solution 4: aqueous solution containing bronopol (Pyceze (trademark)). Each of the chemical solutions was diluted with sterilized tap water. More specifically each of fee chemical solutions 1 to 3 was diluted so feat fee concentrations of chlorine dioxide were adjusted to 0.1 ppm to 1200 ppm, and the chemical solution 4 was diluted so feat fee concentrations of bronopol were adjusted to 0.1 ppm to 1200 ppm. It is to be noted that “Food additive. Sodium chlorite water (50000 ppm as a chlorine dioxide concentration)” manufactured by SUKEGAWA CHEMICALS CO., LTD was used as a sodium chlorite preparation.

[Experiment 2: Sensitized Time 60 min]

An experiment was performed in the same manner as in Experiment 1 except that the mixture obtained by adding 900 μL of the chemical solution to the sterilized tube was stirred and then allowed to stand for 60 minutes for sensitization.

The results of Experiments 1 and 2 are shown in Tables 1 and 2, respectively Tables 1 and 2 show also the results of Blank test in which 900 μL of sterilized tap water was added instead of the chemical solution. It is to be noted that the pH of the mixture in the sterilized tube after adding 900 μL of each of the chemical solutions 1 to 3 was also shown.

TABLE 1

| | | Concentration (ppm) | | | | | | | | | | | | | |
|---|---|---|---|---|---|---|---|---|---|---|---|---|---|---|---|
| Chemical Solution | Items | 1200 | 500 | 300 | 200 | 100 | 50 | 25 | 10 | 5 | 2.5 | 1 | 0.5 | 0.25 | 0.1 |
| Chemical Solution 1 | pH | 7.0 | 7.0 | 6.0 | 6.0 | 6.0 | 6.0 | 6.0 | 6.0 | 6.0 | 6.0 | 6.0 | 6.0 | 6.0 | 6.0 |
| | Zoospores | − | − | − | − | − | − | − | − | + | + | + | + | + | + |
| | Haze | − | − | − | + | + | + | + | + | + | + | + | + | + | + |
| Chemical Solution 2 | pH | 3.0 | 4.0 | 4.5 | 4.5 | 5.0 | 5.0 | 5.0 | 6.0 | 6.0 | 6.0 | 6.0 | 6.0 | 6.0 | 6.0 |
| | Zoospores | − | − | − | − | − | − | − | − | − | − | − | − | − | − |
| | Haze | − | − | − | + | + | + | + | + | + | + | + | + | + | + |
| Chemical Solution 3 | pH | 7.0 | 7.0 | 6.5 | 6.0 | 6.0 | 6.0 | 6.0 | 6.0 | 6.0 | 6.0 | 6.0 | 6.0 | 6.0 | 6.0 |
| | Zoospores | − | − | − | − | − | − | − | + | + | + | + | + | + | + |
| | Haze | − | + | + | + | + | + | + | + | + | + | + | + | + | + |
| Chemical Solution 4 | Zoospores | − | − | − | − | − | − | + | + | + | + | + | + | + | + |
| | Haze | + | + | + | + | + | + | + | + | + | + | + | + | + | + |

| | | |
|---|---|---|
| Sterilized Water | Zoospores | + |
| (Blank) | Haze | + |

TABLE 2

| | | Concentration (ppm) | | | | | | | | | | | | | |
|---|---|---|---|---|---|---|---|---|---|---|---|---|---|---|---|
| Chemical Solution | Items | 1200 | 500 | 300 | 200 | 100 | 50 | 25 | 10 | 5 | 2.5 | 1 | 0.5 | 0.25 | 0.1 |
| Chemical Solution 1 | pH | 7.0 | 7.0 | 6.0 | 6.0 | 6.0 | 6.0 | 6.0 | 6.0 | 6.0 | 6.0 | 6.0 | 6.0 | 6.0 | 6.0 |
| | Zoospores | − | − | − | − | − | − | − | − | − | − | − | + | + | + |
| | Haze | − | − | − | − | − | − | − | − | − | − | + | + | + | + |
| Chemical Solution 2 | pH | 3.0 | 4.0 | 4.5 | 4.5 | 5.0 | 5.0 | 5.0 | 6.0 | 6.0 | 6.0 | 6.0 | 6.0 | 6.0 | 6.0 |
| | Zoospores | − | − | − | − | − | − | − | − | − | − | − | − | − | + |
| | Haze | − | − | − | − | − | + | + | + | + | + | + | + | + | + |
| Chemical Solution 3 | pH | 7.0 | 7.0 | 6.5 | 6.0 | 6.0 | 6.0 | 6.0 | 6.0 | 6.0 | 6.0 | 6.0 | 6.0 | 6.0 | 6.0 |
| | Zoospores | − | − | − | − | − | − | − | − | + | + | + | + | + | + |
| | Haze | − | − | − | + | + | + | + | + | + | + | + | + | + | + |
| Chemical Solution 4 | Zoospores | − | − | − | − | − | − | − | + | + | + | + | + | + | + |
| | Haze | + | + | + | + | + | + | + | + | + | + | + | + | + | + |

| | | |
|---|---|---|
| Sterilized Water | Zoospores | + |
| (Blank) | Haze | + |

As can be seen from Table 1, in the case of a sensitized time of 30 minutes, neither zoospores nor “haze” was observed when the chlorine dioxide concentration of the chemical solutions 1 and 2 was 300 ppm or higher and when the chlorine dioxide concentration of the chemical solution 3 was 500 ppm or higher. On fee other hand, in the case of the chemical solution 4, “haze” was observed even when the concentration of bronopol was 1200 ppm.

As can be seen from Table 2, in the case of a sensitized time of 60 minutes, neither zoospores nor “haze” was observed at a chlorine dioxide concentration of 2.5 ppm or higher only when the chemical solution 1 was used.

That is, it was confirmed from fee results of Experiment 2, in which the sensitized time was set to 60 minutes, that when an organic or inorganic acid was not used the minimum killing concentration of chlorite (sodium chlorite) for water molds (genus Saprolegnia) was 2.5 ppm. The standard pH value of tap water is set to 5.8 to 8.6. Also when tire pH of the mixture in the sterilized tube after adding 900 μL of the chemical solution was adjusted to 5.5 and 8.5, the same results as Experiments 1 and 2 were obtained.

On the other hand, in the case of bronopol that is the only chemical regarded in our country as

effective at preventing water-mold disease in fish farms, the occurrence of “haze” could not be prevented by 60-min sensitization even at a high concentration of 1200 ppm. “Haze” is caused by colonies of water molds. Therefore, it was confirmed from the results of Experiments 1 and 2 that chlorite (sodium chlorite) exerted an excellent sterilizing effect on water molds at a much lower concentration as compared to bronopol.

When bronopol is used, its upper concentration limit is set to 100 ppm. It was confirmed from the results of Experiments 1 and 2 that when used at such a concentration, bronopol was effective at killing zoospores of water molds but had no effect on controlling “haze”. Further, “haze” could not be controlled even when the concentration of bronopol was increased to as high as 10 times or more the upper concentration limit.

Pyceze (trademark) is commercially available as a one-liter product containing 50 mass % of bronopol as an active ingredient, and it costs about 18 yen/L to adjust fee concentration of bronopol to 1200 ppm. On the other hand, it costs 0.055 yen/L to adjust the concentration of an aqueous sodium chlorite solution to 2.5 ppm in terms of chlorine dioxide. That is, the method according to the present invention makes it possible to effectively control water-mold disease and sterilize fish eggs at a cost of less than 1/300 of that when bronopol is used. Further, used aquaculture water does not need to be diluted before discharge, which further makes it possible to economically and efficiently control water-mold disease and sterilize fish eggs.

The concentration of chlorite needs to be 2.5 ppm or higher in terms of chlorine dioxide, and the sensitized time needs to be 60 minutes or longer. However, tor example, when many zoospores of water molds are present, it is preferred that the concentration of chlorine dioxide is set to a higher level and tire sensitized time is set to 60 minutes or longer. If the concentration of chlorine dioxide in aquaculture water is excessively increased, the cost of fee chemical is increased and there is concern for adverse effect on cultured fish or fish eggs. For this reason, fee concentration of chlorous acid in aquaculture water is practically set to 200 ppm or lower in terms of effective chlorine dioxide. The cost of adjusting the concentration of chlorine dioxide to 200 ppm is 4.4 yen/L, which is about ¼ of about 18 yen/L that is the cost of adjusting fee concentration of bronopol to 1200 ppm.

The time of sensitization with chlorite (chlorine dioxide) shall be set to 60 minutes or longer. When fee sensitized time is further increased, it can be expected feat a sterilizing effect on water molds will be obtained even at a lower chlorine dioxide concentration.

Here, the chemical solutions 2 and 3 also contain chlorine dioxide at the same concentration as the chemical solution 1. However, as shown in Table 2, the minimum killing concentration of chlorine dioxide as an active ingredient was 100 ppm in the case of the chemical solution 2 and 300 ppm in fee case of the chemical solution 3. That is, it was confirmed that although fee chemical solutions 2 and 3also contained chlorine dioxide as an active ingredient exerting a sterilizing effect on water molds, the chemical solutions 2 and 3 were less effective ton the chemical solution 1. The chemical solution 1 contains only sodium chlorite, and the chemical solutions 2 and 3 contain also malic acid (organic acid) and hydrochloric acid (inorganic acid), respectively. It is common technical knowledge that stabilized chlorine dioxide such as sodium chlorite is used together with an organic or inorganic acid as an activating component to generate chlorous acid, chlorite ion, and chlorine dioxide so that a sterilizing effect is exerted. Surprisingly, however, it was first confirmed that when an organic or inorganic acid was not used as in the case of the chemical 1, stabilized chlorine dioxide exerted a sterilizing effect on water molds at a lower concentration.

It is considered that sodium chlorite needs to be used together with an acid to form acidified sodium chlorite with pH 23 to 2.9 having a sterilizing effect sufficient, for use as a food additive (April 3,2013, Ministry of Health, Labour and Welfare, Working Group on Food Additives, Food Sanitation Subcommittee, Pharmaceutical Affairs and Food Sanitation Council, Attachment. 1-2). Further, an aqueous sodium chlorite solution is alkaline, and sodium chlorite itself is considered to have little sterilizing capability (The Japan Food Journal, May 26, 2014). However, it was confirmed from the results of Experiments 1 and 2 that sodium chlorite exerted an excellent sterilizing effect on water molds without using an organic or inorganic acid.

The minimum killing concentration of the chemical solution 1 was 300 ppm in Experiment 1 in which tie sensitized time was 30 minutes, but was 2.5 ppm in Experiment 2 in which the sensitized time was 60 minutes. That is, it was confirmed tot according to the present invention, when the sensitized time was set to 60 minutes or longer, an unexpected effect was exerted so that the minimum killing concentration was reduced to 1/120 or less of tot when the sensitized time was set to 30 minutes as in file case of Pyceze (trademark) as a bronopol preparation.

### INDUSTRIAL APPLICABILITY

The present invention is useful in the technical field of fish culture or fishery.

1. A method for controlling water molds in aquaculture water by using chlorite, the method comprising:
adding chlorite to aquaculture water with a pH of 5.5 or higher but 8.5 or lower at a concentration of 2.5 ppm or higher but 200 ppm or lower in terms of effective chlorine dioxide and performing a reaction for 60 minutes or longer to control water molds, wherein
an organic or inorganic acid is not added to the aquaculture water.
